(19) United States
(12) Patent Application Publication
(10) Pub. No.: US 2026/0213107 A1
(43) Pub. Date: Jul. 23, 2026

(54) CIRCUIT BREAKER

(71) Applicant: FUJI ELECTRIC FA COMPONENTS & SYSTEMS CO., LTD., Konosu-city (JP)

(72) Inventors: Ryuichiro YAMAMURA, Konosu-city (JP); Kazuki NAGAMINE, Saitama-city (JP)

(73) Assignee: FUJI ELECTRIC FA COMPONENTS & SYSTEMS CO., LTD., Konosu-city (JP)

(21) Appl. No.: 19/437,816

(22) Filed: Dec. 31, 2025

(30) Foreign Application Priority Data
Jan. 17, 2025 (JP) 2025-006541

(51) Int. Cl. H01H 71/52; H01H 9/30; H01H 71/02

(52) U.S. Cl. CPC H01H 71/528; H01H 9/30; H01H 71/0207; H01H 71/025; H01H 2009/305

(57) ABSTRACT

A circuit breaker prevents adverse effects on an opening/closing mechanism by suppressing the large-scale outflow of arc gases, generated during a current-limiting opening operation of a movable contact piece, into a space in which the opening/closing mechanism is housed. In the circuit breaker, a first space in which a switching contact, a holder unit, and an arc-extinguishing device are housed is separated by a case inner wall from a second space in which an opening/closing mechanism are housed. The case inner wall has a lower toggle passage hole connecting the first space to the second space and extending along an operating range of a lower toggle of a toggle link mechanism coupled to the holder unit. A shutter section configured to block part of the lower toggle passage hole from the first space side in synchronization with the operation of the lower toggle during a current-limiting opening operation of a movable contact piece is provided.

### CROSS REFERENCE TO RELATED APPLICATIONS AND INCORPORATION BY REFERENCE

This application claims benefit of priority under 35 U.S.C. § 119 based on Japanese Patent Application No. 2025-006541 filed on Jan. 17, 2025, the entire contents of which are incorporated by reference herein.

### TECHNICAL FIELD

The present invention relates to a circuit breaker.

### BACKGROUND ART

A circuit breaker includes, in a body case: a switching contact constituted by a fixed contact piece having a fixed contact point, and a movable contact piece having a movable contact point; a holder unit rotatably supporting a base end of the movable contact piece; an opening/closing mechanism including a toggle link mechanism connecting an opening and closing handle to the movable contact piece; and an arc-extinguishing device or arc chute (e.g., JP 2006-294511 A).

When an arc and arc gases are generated between the fixed contact point and the movable contact point during a current-limiting opening operation of the movable contact piece, and the arc gases strongly flow toward a gas discharge port of the arc-extinguishing device, the circuit breaker rapidly directs the arc into grids of the arc-extinguishing device to sharply increase arc voltage, thereby improving interruption performance.

### SUMMARY OF INVENTION

### Technical Problem

In the body case of the circuit breaker, a first space in which the switching contact, the holder unit, and the arc-extinguishing device are housed is separated by a case inner wall from a second space in which the opening/closing mechanism is housed. A lower toggle constituting the toggle link mechanism of the opening/closing mechanism is connected to a holder case of the holder unit, and the case inner wall has a lower toggle passage hole connecting the first space to the second space and allowing the lower toggle to pass therethrough.

Here, when a large volume of arc gases containing metallic particles and resin evaporating due to arc heat generated in the first space flows out into the second space via the lower toggle passage hole, the opening/closing mechanism might be adversely affected.

When a large volume of arc gases in the first space flows out into the second space, a force (the flow of the arc gases) to push the arc in the first space into the arc-extinguishing device weakens, which might decrease interruption performance.

In view of this, an object of the present invention is to provide a circuit breaker which can prevent adverse effects on an opening/closing mechanism by suppressing the large-scale outflow of arc gases, generated during a current-limiting opening operation of a movable contact piece, into a space in which the opening/closing mechanism is housed, and which can improve interruption performance by causing the flow of the arc gases to act as a force to push an arc into an arc-extinguishing device.

### Solution to Problem

In order to achieve the above object, a circuit breaker according to one aspect of the present invention includes: a switching contact including a fixed contact piece having a fixed contact point and a movable contact piece having a movable contact point; a holder unit rotatably supporting a base end of the movable contact piece; an opening/closing mechanism including a toggle link mechanism coupling an opening and closing handle to the movable contact piece; an arc-extinguishing device; a case in which the switching contact, the holder unit, the opening/closing mechanism, and the arc-extinguishing device are housed, the case including a case inner wall separating a first space in which the switching contact, the holder unit, and the arc-extinguishing device are housed from a second space in which the opening/closing mechanism is housed, the case inner wall having a lower toggle passage hole connecting the first space to the second space and extending along an operating range of a lower toggle of the toggle link mechanism coupled to the holder unit; and a shutter configured to block part of the lower toggle passage hole from the first space side in synchronization with an operation of the lower toggle during a current-limiting opening operation of the movable contact piece.

### Advantageous Effects of Invention

With the circuit breaker according to the present invention, it is possible to prevent adverse effects on an opening/closing mechanism by suppressing arc gases, generated during a current-limiting opening operation of a movable contact piece, from flowing out into a space in which the opening/closing mechanism is housed, and to improve interruption performance by causing the flow of the arc gases to act as a force to push an arc into an arc-extinguishing device.

### BRIEF DESCRIPTION OF DRAWINGS

FIG. 1 is a sectional view illustrating a circuit breaker according to the present invention.

FIG. 2 is a sectional view illustrating the position of a lower toggle of a toggle link mechanism while a switching contact is in an ON state.

FIG. 3 is a perspective view illustrating a movable element unit.

FIG. 4 is a perspective view illustrating a holder case constituting a holder unit.

FIG. 5 is a perspective view illustrating a state where the lower toggle, the movable element unit, and a toggle shutter are disposed in the holder unit.

FIG. 6 is a perspective view illustrating the shape of the toggle shutter.

FIG. 7 is a sectional view illustrating the positions of the lower toggle and the toggle shutter during a current-limiting opening operation of a movable contact piece.

### DESCRIPTION OF EMBODIMENTS

With reference to the drawings, the following describes embodiments of the present invention. In the drawings to be referred to in the following description, identical or similar portions have identical or similar reference signs. Note that the drawings are schematic, and the relationship between thickness and flat dimension, the ratio between layer thicknesses, and the like are different from actual ones. Accordingly, a specific thickness or dimension should be determined in consideration of the following description. It goes without saying that the drawings include portions having different dimensional relationships or ratios.

Each embodiment of the present invention describes a device or a method to embody the technical idea of the present invention, and the technical idea of the present invention does not specify the quality, shape, structure, arrangement, or the like of constituent components to those described below. Various changes can be added to the technical idea of the present invention within the technical scope defined by claims described in Claims.

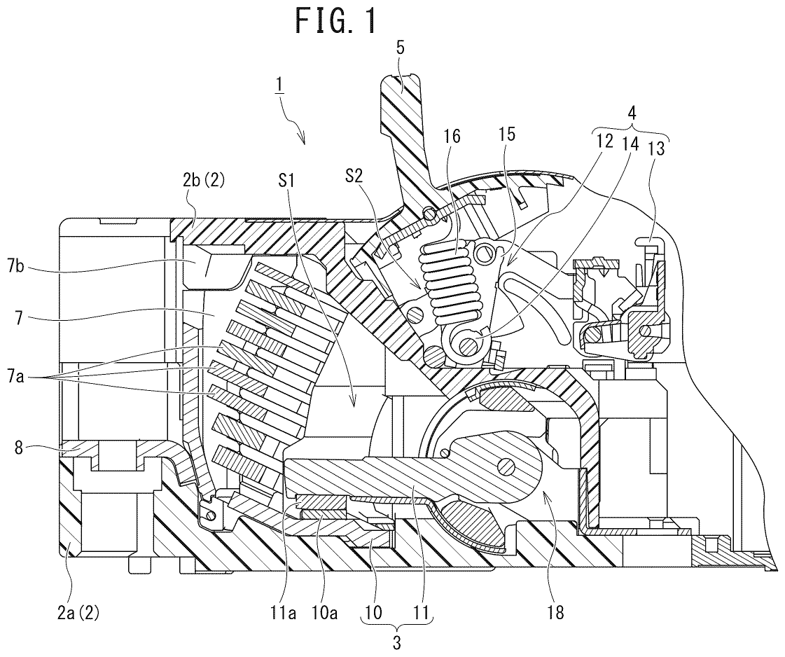

FIG. 1 is an essential-part sectional view illustrating a circuit breaker 1 for three-phase (R, S, T) alternating current according to a first embodiment, which is connected between a power source side and a load side in a circuit, and illustrates a circuit structure of one phase among the three phases incorporated in parallel in a body case 2.

The circuit breaker 1 includes an opening/closing mechanism 4 configured to open and close a switching contact 3, an opening and closing handle 5 configured to operate the opening/closing mechanism 4, and an arc-extinguishing device 7, which are arranged in the body case 2. Note that the body case 2 corresponds to a case described in the present invention.

The body case 2 is configured such that a power-source-side intermediate case 2b and a load-side intermediate case (not illustrated) are assembled to a lower case 2a in an overlapping state, and a top cover (not illustrated) is assembled to the power-source-side intermediate case 2b and the load-side intermediate case in an overlapping state. A power-source-side main circuit terminal 8 and a load-side main circuit terminal (not illustrated) are fixed to the lower case 2a. In a first space S1 surrounded by the lower case 2a and the power-source-side intermediate case 2b of the body case 2, the switching contact 3, the holder unit 18, and the arc-extinguishing device 7 are housed. The opening/closing mechanism 4 is housed in a second space S2 surrounded by the power-source-side intermediate case 2b and the top cover. Note that the power-source-side intermediate case 2b corresponds to a case inner wall described in the present invention.

The switching contact 3 is constituted by a fixed contact piece 10 having a fixed contact point 10a, and a movable contact piece 11 having a movable contact point 11a. The movable contact piece 11 is rotatably supported by a holder unit 18. The fixed contact piece 10 is connected to the power-source-side main circuit terminal 8, and the movable contact piece 11 is connected to the load-side main circuit terminal via a holder base 22 of the holder unit 18 and an overcurrent tripping device (not illustrated).

The arc-extinguishing device 7 includes a plurality of grids 7a arranged in layered form, and a gas discharge port 7b communicating with the outside on a side of respective end portions of the plurality of grids 7a which end portions are separated from the switching contact 3.

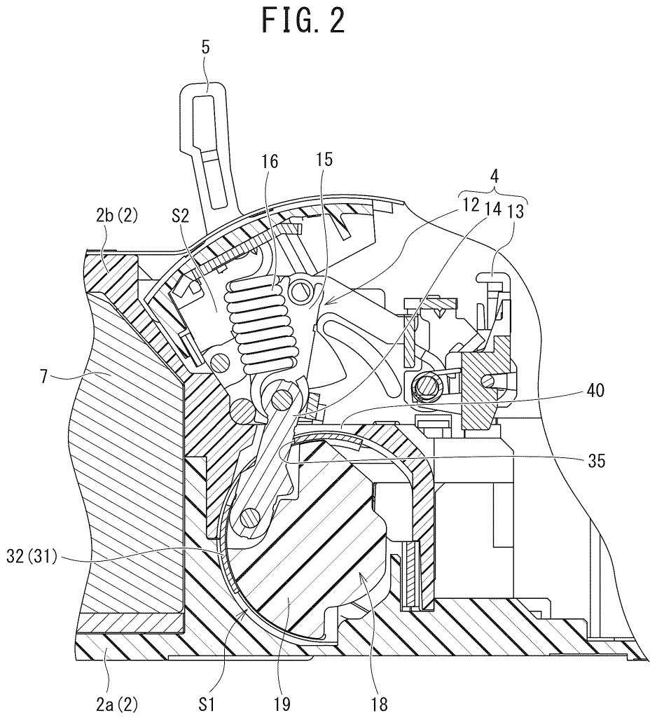

The opening/closing mechanism 4 includes a toggle link mechanism 12 connecting the movable contact piece 11 to the opening and closing handle 5, and a trip crossbar 13. As illustrated in FIG. 2, the toggle link mechanism 12 includes a lower toggle 14 having a lower portion connected via a pin to a holder case 19 of the holder unit 18, an upper toggle 15 connected via a pin to an upper portion of the lower toggle 14 and a latch mechanism (not illustrated), and an opening and closing spring 16 disposed between the opening and closing handle 5 and a lower portion of the upper toggle 15. When the trip crossbar 13 rotates in the counterclockwise direction, the movable contact piece 11 performs an opening operation in response to a tripping operation of the opening/closing mechanism 4.

Here, as illustrated in FIG. 2, the power-source-side intermediate case 2b has a lower toggle passage hole 40 connecting the first space S1 to the second space S2, and the lower toggle 14 extending through the lower toggle passage hole 40 is connected via pins to the holder case 19 and the upper toggle 15.

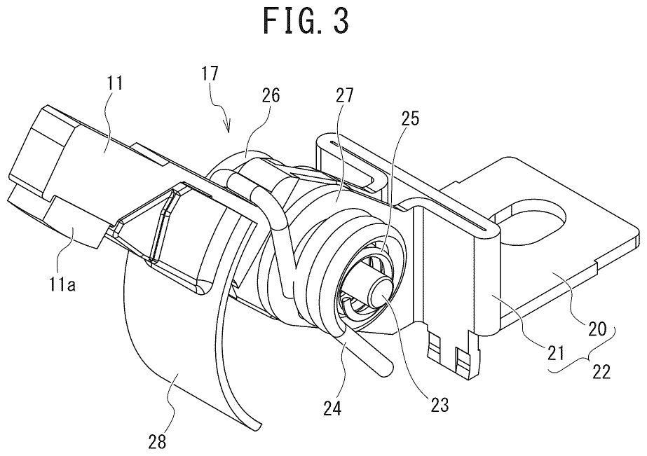

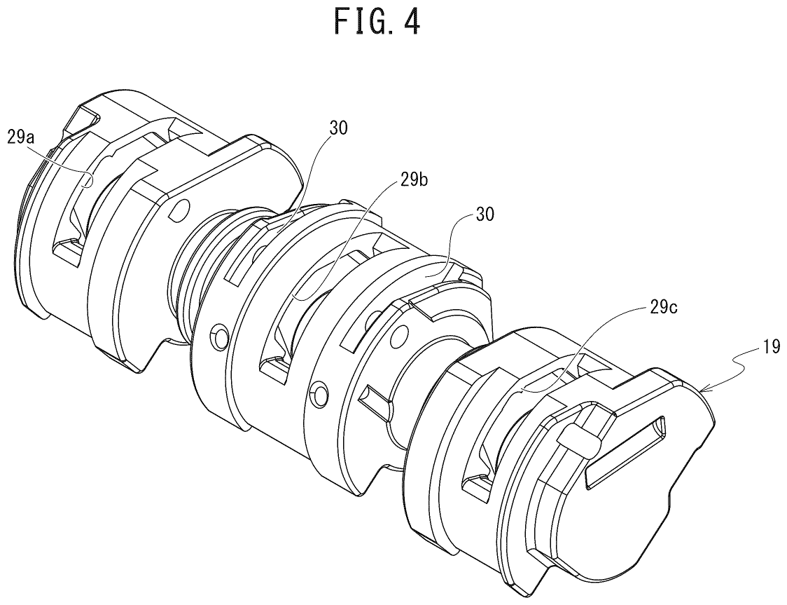

The holder unit 18 includes a movable element unit 17 illustrated in FIG. 3, and a holder case 19 in which a base end side of the movable element unit 17, illustrated in FIG. 4, is housed.

As illustrated in FIG. 3, the movable element unit 17 includes the holder base 22 including a connection plate 20 and a support 21, a movable-element rotating shaft 23 attached to the support 21 and rotatably supporting the movable contact piece 11, a movable-element pressure contact spring 24, and a sliding-contactor pressure contact spring 25. The support 21 of the holder base 22 includes a pair of plate-shaped sliding contactors 26, 27 extending in parallel to each other and having respective shaft holes (not illustrated) through which the movable-element rotating shaft 23 extends. A movable protective cover 28 formed of synthetic resin is attached to the bottom side (the movable contact point 11a side) of the movable contact piece 11. A pair of sliding-contactor pressure contact springs 25 disposed inside the holder case 19 are disposed on the outer surfaces of the pair of sliding contactors 26, 27 to surround the movable-element rotating shaft 23 and apply spring forces in a direction where the pair of sliding contactors 26, 27 are closely brought into surface contact with the base end portion of the movable contact piece 11. The movable-element pressure contact spring 24 disposed inside the holder case 19 applies a spring restoration force to the movable contact piece 11 in its closing direction.

As illustrated in FIG. 4, the holder case 19 is generally cylindrical member which is formed of a dielectric material and in which movable element units 17 for three phases are mounted in parallel. The holder case 19 has three movable element passage holes 29a to 29c formed at respective positions separated from each other in the longitudinal direction of the holder case 19 and extending in the circumferential direction of the holder case 19. The holder case 19 also has two lower toggle rotation holes 30 extending in the circumferential direction, at respective positions sandwiching the movable element passage hole 29b located at the center of the holder case 19 in the longitudinal direction.

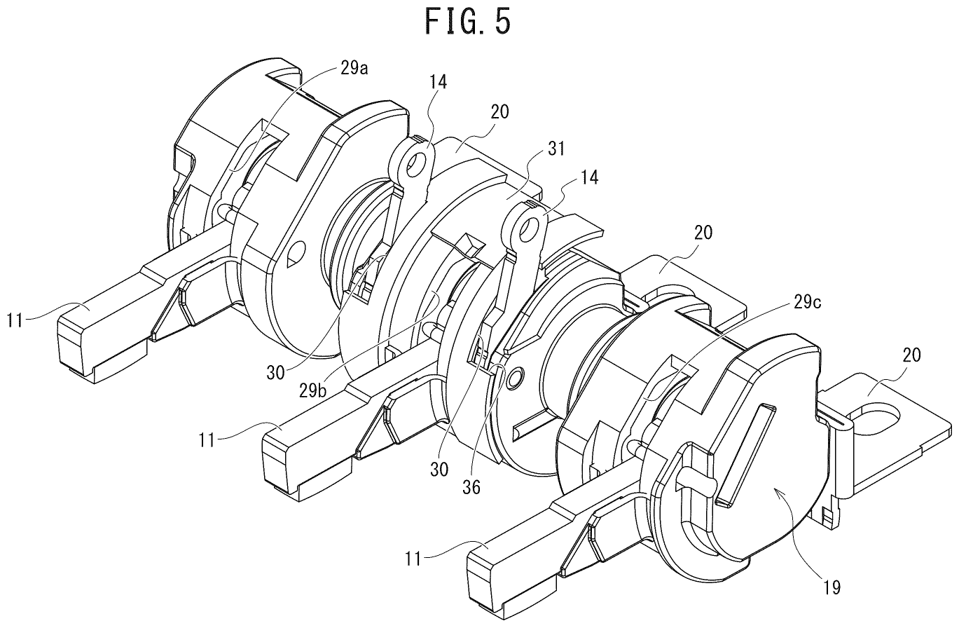

FIG. 5 is a view illustrating the movable element units 17 for three phases, a pair of lower toggles 14, and a toggle shutter 31 are mounted in the holder case 19.

The movable element unit 17 is disposed such that the holder base 22, the movable-element rotating shaft 23, the movable-element pressure contact spring 24, and the sliding-contactor pressure contact springs are mounted inside the holder case 19 with the movable contact piece 11 projecting outside through the movable element passage hole 29. The lower toggle 14 is disposed with its lower portion connected to the inside of the holder case 19 via a pin and its upper side projecting outside through the lower toggle rotation hole 30.

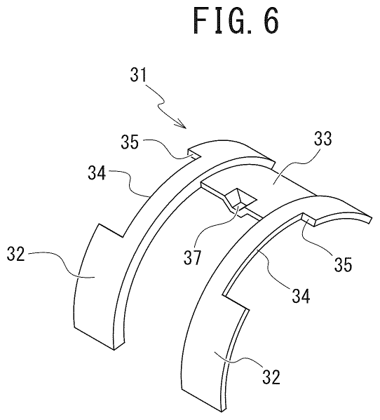

The toggle shutter 31 is a member formed of a dielectric material and includes a pair of shutter sections 32, 32, and a coupler 33 coupling one end sides of the pair of shutter sections 32, 32 in their longitudinal direction to each other, as illustrated in FIG. 6. The pair of shutter sections 32, 32 have symmetric curved elongated plate shapes sandwiching the coupler 33 therebetween and have notches 34 formed in their central portions in the longitudinal direction. An engagement section 35 is formed at one end of each notch 34 in its longitudinal direction. The coupler 33 includes a projection 37 projecting downward. Note that the engagement section 35 corresponds to a lower toggle engagement section described in the present invention, and the projection 37 corresponds to a guide section described in the present invention.

As illustrated in FIG. 5, the toggle shutter 31 is disposed to cover the outer periphery of the movable element passage hole 29b at the center of the holder case 19 in the longitudinal direction, with the projection 37 engaged with the peripheral edge of the movable element passage hole 29b and the lower toggles 14 extending through the notches 34.

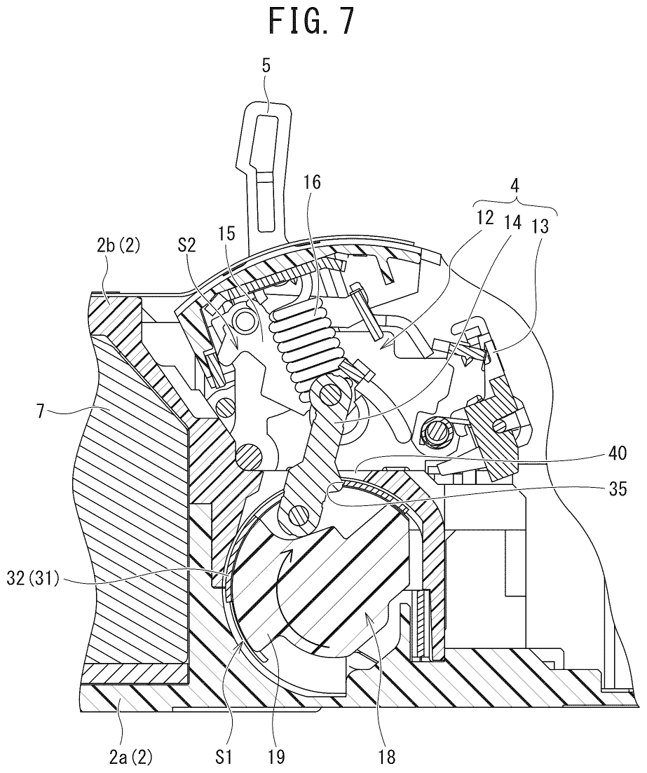

Next will be described the operation of the circuit breaker 1 according to the present embodiment with reference to FIG. 7.

When excess current flows between the power-source-side main circuit terminal 8 and the load-side main circuit terminal in the circuit breaker 1, the movable contact piece 11 starts a current-limiting opening operation. In response to the movable contact piece 11 starting the current-limiting opening operation, the holder case 19 rotates in an arrow direction. In synchronization with the rotation of the holder case 19, the lower toggle 14 comes close to the opening and closing spring 16 and move toward the trip crossbar 13 side.

In response to engagement of part of the lower toggle 14 with the engagement section 35 of the shutter section 32, the toggle shutter 31 also moves with the lower toggle 14. At this time, since the projection 37 of the toggle shutter 31 slides over the peripheral edge of the movable element passage hole 29b, the toggle shutter 31 is guided in a regular movement direction so that the shutter section 32 moves to cover the lower toggle passage hole 40.

In the end of the current-limiting opening operation of the movable contact piece 11, the shutter section 32 of the toggle shutter 31 moving in synchronization with the operation of the lower toggle 14 reduces the aperture area of the lower toggle passage hole 40.

Accordingly, in response to the movable contact piece 11 starting the current-limiting opening operation, the aperture area of the lower toggle passage hole 40 connecting the first space S1 to the second space S2 is set to be small by the lower toggle 14 and the shutter section 32 of the toggle shutter 31. Hereby, it is possible to suppress the volume of arc gases which contain metallic particles and resin evaporating due to arc heat generated in the first space S1 and which flow out into the second space S2, thereby making it possible to prevent adverse effects on the opening/closing mechanism 4.

Besides, it is possible to suppress the large-scale outflow of arc gases in the first space S1 and cause the flow of the arc gases to act as a force to push an arc into the arc-extinguishing device, thereby making it possible to improve interruption performance.

At the time when the toggle shutter 31 moves in synchronization with the operation of the lower toggle 14, the projection 37 slides over the peripheral edge of the movable element passage hole 29b. As a result, the toggle shutter 31 can be guided in the regular movement direction so that the shutter section 32 moves to block the lower toggle passage hole 40.

### REFERENCE SIGNS LIST

1: circuit breaker
2: body case
2a: lower case
2b: power-source-side intermediate case
3: switching contact
4: opening/closing mechanism
5: opening and closing handle
7: arc-extinguishing device
7a: grid
7b: gas discharge port
8: power-source-side main circuit terminal
10a: fixed contact point
10: fixed contact piece
11a: movable contact point
11: movable contact piece
12: toggle link mechanism
13: trip crossbar
14: lower toggle
15: upper toggle
16: opening and closing spring
17: movable element unit
18: holder unit
19: holder case
20: connection plate
21: support
22: holder base
23: movable-element rotating shaft
24: movable-element pressure contact spring
25: sliding-contactor pressure contact spring
26, 27: sliding contactor
28: movable protective cover
29a to 29c: movable element passage hole
30: lower toggle rotation hole
31: toggle shutter
32: shutter section
33: coupler
34: notch
35: engagement section
37: projection
40: lower toggle passage hole
S1: first space
S2: second space

1. A circuit breaker comprising:
a switching contact including a fixed contact piece having a fixed contact point and a movable contact piece having a movable contact point;
a holder unit rotatably supporting a base end of the movable contact piece;
an opening/closing mechanism including a toggle link mechanism coupling an opening and closing handle and the movable contact piece;
an arc-extinguishing device;
a case that houses the switching contacts, the holder unit, the opening/closing mechanism, and the arc-extinguishing device, the case including a case inner wall that separates a first space, in which the switching contacts, the holder unit, and the arc-extinguishing device are housed, from a second space, in which the opening/closing mechanism is housed, the case inner wall having a lower-toggle passage hole that communicates the first and second spaces and extends along an operating range of a lower toggle of the toggle link mechanism coupled to the holder unit; and
a shutter section configured to block part of the lower toggle passage hole from the first space side in synchronization with an operation of the lower toggle during a current-limiting opening operation of the movable contact piece.

2. The circuit breaker according to claim 1, wherein
the shutter section is disposed to be slidable over an outer periphery of a holder case of the holder unit and configured to move to a position that blocks the lower toggle passage hole, in synchronization with the operation of the lower toggle.

3. The circuit breaker according to claim 2, wherein
the shutter section includes a lower toggle engagement section configured to be engaged with the lower toggle to move the shutter section in synchronization with the lower toggle during the current-limiting opening operation of the movable contact piece.

4. The circuit breaker according to claim 2, wherein
the shutter section includes a guide section configured to guide the shutter section to move the shutter section along a direction where the lower toggle operates.

5. The circuit breaker according to claim 4, wherein:
the holder case has a movable element passage hole along an operating range of the movable contact piece;
the shutter section includes a projection configured to be engaged with a peripheral edge of the movable element passage hole; and
the projection configured to slide over the peripheral edge of the movable element passage hole in response to movement of the shutter section serves as the guide section.
